(19) United States
(12) Patent Application Publication
(10) Pub. No.: US 2019/0283766 A1
(43) Pub. Date: Sep. 19, 2019

(54) DRIVETRAIN COMPENSATION FOR AUTONOMOUS VEHICLES

(71) Applicant: Uber Technologies, Inc., San Francisco, CA (US)

(72) Inventors: Kenneth James Jensen, Alameda, CA (US); Edward Henry Lim, Pacifica, CA (US)

(21) Appl. No.: 16/012,226

(22) Filed: Jun. 19, 2018

Related U.S. Application Data
(60) Provisional application No. 62/644,952, filed on Mar. 19, 2018.

(51) Int. Cl. B60W 40/107; B60W 10/10; B60W 30/18

(52) U.S. Cl. CPC B60W 40/107; B60W 2050/0011; B60W 30/18; B60W 10/10

(57) ABSTRACT

Various examples are directed to systems and methods for at least partially controlling a vehicle. A vehicle system may access motion plan data for the vehicle. The vehicle system may generate drivetrain bias data representative of drivetrain effects of the vehicle. The vehicle system may generate a biased throttle command using the motion plan data and the drivetrain bias data and apply the biased throttle command to a propulsion system of the vehicle.

### CLAIM FOR PRIORITY

This application claims the benefit of priority of U.S. Provisional Application No. 62/644,952, filed Mar. 19, 2018, which is hereby incorporated by reference in its entirety.

### FIELD

The document pertains generally, but not by way of limitation, to devices, systems, and methods for operating an autonomous vehicle.

### BACKGROUND

An autonomous vehicle is a vehicle that is capable of sensing its environment and operating some or all of the vehicle's controls based on the sensed environment. An autonomous vehicle includes sensors that capture signals describing the environment surrounding the vehicle. The autonomous vehicle processes the captured sensor signals to comprehend the environment and automatically operates some or all of the vehicle's controls based on the resulting information.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment for implementing drivetrain compensation.

FIG. 2 depicts a block diagram of an example vehicle according to example aspects of the present disclosure.

FIG. 3 is a flowchart showing one example of a process flow that may be executed at an autonomous vehicle to apply drivetrain compensation to a throttle command.

FIG. 4 is a flowchart showing one example of a process flow that may be executed at an autonomous vehicle to generate a biased throttle command by applying a speed bias.

FIG. 5 is a flowchart showing one example of a process flow that may be executed at an autonomous vehicle to generate a biased throttle command by applying an acceleration bias.

FIG. 6 is a chart showing one example workflow that may be executed at an autonomous vehicle to generate a biased throttle command by applying a speed bias.

FIG. 7 is a chart showing one example of a workflow that may be executed at an autonomous vehicle to generate a biased throttle command by applying an acceleration bias.

FIG. 8 is a block diagram showing one example of a software architecture for a computing device.

FIG. 9 is a block diagram illustrating a computing device hardware architecture, within which a set or sequence of instructions can be executed to cause a machine to perform examples of any one of the methodologies discussed herein.

### DESCRIPTION

Examples described herein are directed to systems and methods for modifying or biasing a throttle command for controlling a throttle in a vehicle.

In an autonomous or semi-autonomous vehicle (collectively referred to as an autonomous vehicle (AV)), a vehicle autonomy system, sometimes referred to as an AV stack, controls one or more of braking, steering, or the throttle of the vehicle. In a fully-autonomous vehicle, the vehicle autonomy system assumes full control of the vehicle. In a semi-autonomous vehicle, the vehicle autonomy system assumes a portion of the vehicle control, with a human user (e.g., a vehicle operator) still providing some control input.

The vehicle autonomy system, in some examples, provides a throttle command to a propulsion system for the vehicle, such as an engine of the vehicle. The throttle command is provided directly to the engine and/or indirectly via an engine controller. The throttle command controls the engine speed (e.g., revolutions per minute (RPM)) and, therefore, the torque provided by the engine to the drive wheels of the vehicle. For example, a throttle command may call for an increase in engine speed to provide additional torque to the wheels or a decrease in engine speed to provide less torque to the wheels, or no change in engine speed to maintain the current torque to the wheels.

Many vehicles include an automatic transmission or automated manual transmission in which gear changes are determined automatically (e.g., without a gear change command from the human user or vehicle autonomy system). The transmission shifts or changes gears based on various factors including engine speed, road grade, the amount of throttle called for by the throttle command, etc. For example, when the RPMs of the engine increase to an upshift point, the transmission shifts to a next higher gear. When the RPMs of the engine decrease to a downshift point, the transmission shifts to a next lower gear. Also, for example, if a throttle command calls for a high degree of throttle, the transmission downshifts to the next lower gear to increase acceleration. During gear changes, a clutch is disengaged to disconnect the engine from the remainder of the drivetrain. While the clutch is disengaged, the transmission disengages the current gear and engages the next gear. Then the clutch is engaged and the engine is connected again to the drivetrain to provide torque to the drive wheels according to the gear ratio of the next gear.

Drivetrain effects, such as gear changes, change the way that the vehicle responds to throttle commands. For example, various drivetrain effects cause the engine to briefly pause the provision of motive force to the vehicle. For example, when the primary transmission shifts gears, motive force is interrupted while the clutch is disengaged. Other drivetrain effects include shifts that occur in auxiliary gear boxes, such as range and/or splitter gear boxes that are included in some trucks. Drivetrain effects may also include effects due to the transaxle such as, for example, gear changes at the transaxle, etc.

The vehicle autonomy system of an AV generates throttle commands to operate the vehicle at a desired speed and/or acceleration. Consider an example in which a vehicle autonomy system generates an uncorrected throttle command to operate the vehicle according to a desired acceleration profile. The vehicle may initially conform to the acceleration profile. As gearshifts and/or other drivetrain effects occur, however, acceleration of the vehicle slows (or ceases, for example, when the clutch is engaged). As a result, without drivetrain compensation, the vehicle tends to fall off of the desired acceleration profile.

Various examples described herein are directed to systems and methods for correcting a throttle command for drivetrain effects. A vehicle autonomy system includes or works in conjunction with a throttle control system and/or a throttle correction system. The throttle control system receives motion plan data, for example, from a motion planning system of the vehicle autonomy system, and converts the motion plan data to a throttle command that is provided to an engine or engine controller of the vehicle. The throttle correction system, as described herein, modifies the throttle command to generate a drivetrain-compensated throttle command, referred to herein as a biased throttle command.

In some examples, the motion plan data generated by the motion planning system describes a speed path and an acceleration path. The speed path and acceleration path indicate the planned speed and acceleration, respectively, of the vehicle over time. For example, a speed path may be represented as a function of time, an array in which different array elements indicate different target speeds at different times, a look-up table, or any other suitable data structure. An acceleration path may be similarly represented as a function or as any suitable data structure.

From the speed path, the throttle control system generates a speed force. The throttle control system determines a target speed from the speed path, where the target speed is the speed called for by the speed path at the current time. In some examples, the target speed is the speed called for by the speed path at the current time plus a look-ahead time, where the look-ahead time is to compensate for throttle lag. The throttle control system then determines a speed force, which is a force to be applied to the vehicle by the engine to achieve the target speed.

Similarly, from the acceleration path, the throttle control system generates an acceleration force. The throttle control system generates a target acceleration from the acceleration path, where the target acceleration is the acceleration called for by the acceleration path at the current time (or at the current time plus a look-ahead time to compensate for throttle lag). The throttle control system then determines an acceleration force, which is a force to be applied to the vehicle to achieve the target acceleration.

The throttle control system generates a total force from the speed force and the acceleration force. The throttle control system then generates a throttle command by determining what level of throttle results in the drivetrain applying the total force to the vehicle. The throttle control system applies an inverse drivetrain model to determine a target engine torque, and applies engine map data to the target engine torque and current engine RPM to generate the throttle command, which is provided to the engine (e.g., via an engine controller).

The throttle correction system determines a drivetrain bias and applies the drivetrain bias to generate a biased throttle command. In some examples, the throttle correction system receives a throttle command generated by the throttle control system and applies the drivetrain bias to the throttle command to generate the biased throttle command. In other examples, the throttle correction system provides the drivetrain bias to the throttle control system, which applies the drivetrain bias. In this way, the output of the throttle control system is a biased throttle command.

The drivetrain bias may be determined in any suitable manner. For example, the drivetrain bias may be determined experimentally by measuring the occurrence of drivetrain effects, such as gear changes, and the resulting changes to the vehicle's acceleration profile in response to different test throttle commands in different conditions. The result may be a deterministic function, look-up table, or other relationship that ties a throttle command, target speed, and/or target acceleration to a given drivetrain bias. In some examples, the drivetrain bias is generated from known characteristics of a drivetrain. For example, data describing the shift points of a transmission may be used to generate drivetrain bias data for the transmission.

In some examples, the throttle correction system receives a throttle command and applies the drivetrain bias to the throttle command to generate a biased throttle command. Also, in some examples, the throttle correction system applies a drivetrain speed bias to the target speed applied by the throttle control system. In some examples, the throttle correction system applies a drivetrain acceleration bias to the target acceleration applied by the throttle control system.

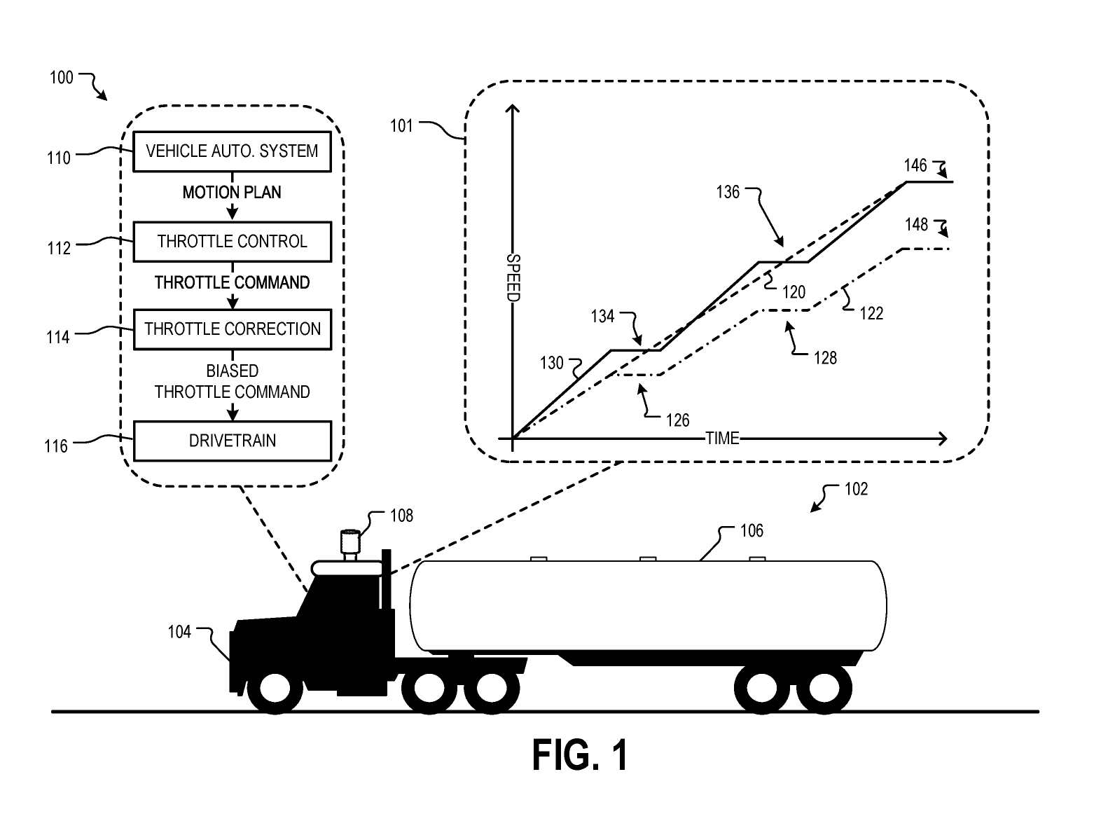

FIG. 1 is a diagram showing one example of an environment 100 for implementing drivetrain compensation. The environment 100 includes a vehicle 102. The vehicle 102 includes a vehicle autonomy system 110, a throttle control system 112, a throttle correction system 114, and a drivetrain 116. Although the vehicle autonomy system 110, throttle control system 112, and throttle correction system 114 are shown as separate systems, in some examples, the functionality of all three systems is distributed over a different number of systems and/or consolidated into a single system (e.g., the vehicle autonomy system 110). In the example of FIG. 1, the vehicle 102 is a tractor-trailer including a tractor 104 and a trailer 106. In various other examples, the vehicle 102 does not include a trailer 106 and may be, for example, a dump truck, a bus, or any other similar vehicle. Also, in some examples, the vehicle 102 is a passenger vehicle.

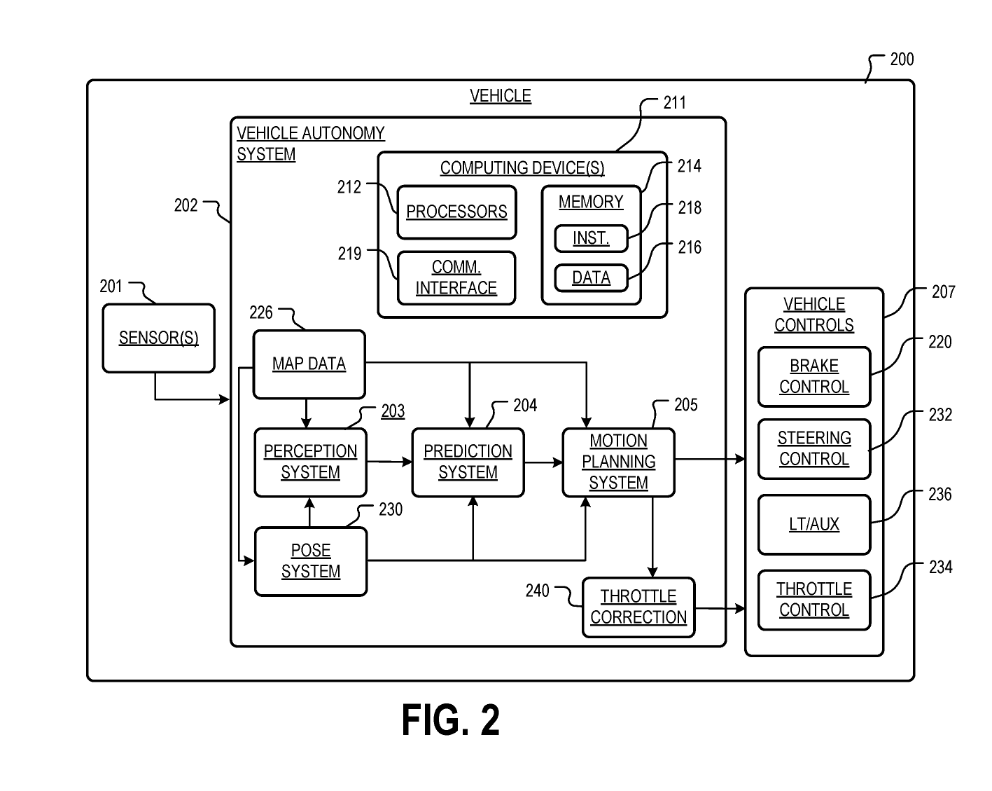

The vehicle 102 is an AV. The vehicle autonomy system 110, for example, is configured to operate some or all of the controls of the vehicle 102 (e.g., acceleration, braking, steering). In some examples, the throttle control system 112 and/or throttle correction system 114 are components of the vehicle autonomy system 110. The vehicle autonomy system 110, in some examples, is operable in different modes in which the vehicle autonomy system 110 has differing levels of control over the vehicle 102. In some examples, the vehicle autonomy system 110 is operable in a fully autonomous mode in which the vehicle autonomy system 110 assumes responsibility for all or most of the controls of the vehicle 102. In addition to or instead of the fully autonomous mode, the vehicle autonomy system 110, in some examples, is operable in a semi-autonomous mode in which a human user or driver is responsible for some or all control of the vehicle 102. Additional details of an example vehicle autonomy system are provided in FIG. 2.

The vehicle 102 has one or more remote-detection sensors 108 that receive return signals from the environment 100. Return signals may be reflected from objects in the environment 100, such as the ground, buildings, trees, etc. The remote-detection sensors 108 may include one or more active sensors, such as light detection and ranging (LIDAR), radio detection and ranging (RADAR), or sound navigation and ranging (SONAR) sensors that emit sound or electromagnetic radiation in the form of light or radio waves to generate return signals. The remote-detection sensors 108 may also include one or more passive sensors, such as cameras or other imaging sensors, proximity sensors, etc. Information about the environment 100 is extracted from the return signals. In some examples, the remote-detection sensors 108 include a passive sensor that receives reflected ambient light or other radiation, such as a set of monoscopic or stereoscopic cameras. The remote-detection sensors 108 provide remote-sensor data that describes the environment 100.

The vehicle autonomy system 110 receives remote-sensor data (and other sensor data) and generates a motion plan for the vehicle 102, which may be described by motion plan data. The motion plan describes a desired acceleration and/or speed curve for the vehicle 102. The throttle control system 112 receives the motion plan and generates a throttle command. In the example of FIG. 1, the throttle command is provided to the throttle correction system 114. The throttle correction system 114 applies a drivetrain bias to the throttle command to generate a biased throttle command. The biased throttle command is provided to the drivetrain 116. The drivetrain 116 includes an engine, transmission, transaxle, and/or other suitable components for providing power to wheels of the vehicle 102. In some examples, the drivetrain 116 also includes an engine controller. For example, the biased throttle command may be provided to the engine controller, which controls the engine throttle in accordance with the biased throttle command to set a speed of the engine.

FIG. 1 also includes a chart 101 showing example acceleration curves 120, 122, 130 for the vehicle 102. A horizontal axis of the chart 101 indicates time, while a vertical axis of the chart 101 indicates speed. Accordingly, the slope of the acceleration curves 120, 122, 130 indicates acceleration. Each of the acceleration curves 120, 122, 130 accelerates the vehicle 102 to a respective final speed. At the respective final speeds, the slope of the curves is reduced and may approach zero as acceleration slows and stops.

An ideal acceleration curve 120 shows how the vehicle 102 would accelerate without drivetrain effects. For example, the ideal acceleration curve 120 shows roughly constant acceleration to a final speed 146. In practice, drivetrain effects, such as gear changes, would cause the vehicle 102 to deviate from the ideal acceleration curve 120. For example, an actual acceleration curve 122 shows how the vehicle 102 would accelerate if it applied the target speed and acceleration of the ideal acceleration curve 120 without drivetrain compensation. The acceleration curve 122 includes acceleration interruptions 126, 128 where acceleration pauses. The acceleration interruptions 126, 128 reflect drivetrain effects of the vehicle 102, such as gear changes. As shown, outside of the acceleration interruptions 126, 128, the slope of the actual acceleration curve 122 is the same as that of the ideal acceleration curve 120. Despite this, the final speed 148 achieved by the actual acceleration curve 122 is less than the final speed 146 of the ideal acceleration curve 122.

The chart 101 also shows a corrected acceleration curve 130 that describes how the vehicle 102 would accelerate with drivetrain compensation, as described herein, to reach the final speed 146 at the same time as with the ideal acceleration curve 120. As shown, the slope of the corrected acceleration curve 130 is higher than that of either the ideal acceleration curve 120 or the actual acceleration curve 122. Acceleration pauses 134, 136 due to drivetrain effects are still present, but because of throttle correction, the vehicle 102 achieves the final speed 146 at the same time as with the ideal acceleration curve 120.

It will be appreciated that the chart 101 shows just one way that the throttle correction system 114 may correct the throttle command to achieve a desired motion plan in view of drivetrain effects. For example, instead of modifying the acceleration curve of the vehicle 102, the throttle correction system 114, in some examples, modifies a final speed of the vehicle 102 and/or a time when the final speed is achieved. Further, the precise number of, placement of, and distortion from drivetrain effects may vary from drivetrain to drivetrain.

FIG. 2 depicts a block diagram of an example vehicle 200 according to example aspects of the present disclosure. The vehicle 200 can be, for example, an autonomous or semi-autonomous vehicle. The vehicle 200 includes one or more sensors 201, a vehicle autonomy system 202, and one or more vehicle control systems 207. In some examples, the vehicle 200 includes a throttle correction system 240, which may operate in a manner similar to that of the throttle correction system 114 described with reference to FIG. 1.

The vehicle autonomy system 202 can be engaged to control the vehicle 200 or to assist in controlling the vehicle 200. In particular, the vehicle autonomy system 202 receives sensor data from the one or more sensors 201, attempts to comprehend the environment surrounding the vehicle 200 by performing various processing techniques on data collected by the sensors 201, and generates an appropriate motion path through the environment. The vehicle autonomy system 202 can control the one or more vehicle controls 207 to operate the vehicle 200 according to the motion path.

The vehicle autonomy system 202 includes a perception system 203, a prediction system 204, a motion planning system 205, and a pose system 230 that cooperate to perceive the surrounding environment of the vehicle 200 and determine a motion plan for controlling the motion of the vehicle 200 accordingly. The pose system 230 may be arranged to operate as described herein.

Various portions of the vehicle autonomy system 202 receive sensor data from the one or more sensors 201. For example, the sensors 201 may include remote-detection sensors as well as motion sensors such as an inertial measurement unit (IMU), one or more encoders, one or more odometers, etc. The sensor data can include information that describes the location of objects within the surrounding environment of the vehicle 200, information that describes the motion of the vehicle 200, etc.

The sensors 201 may also include one or more remote-detection sensors or sensor systems, such as a LIDAR system, a RADAR system, one or more cameras, etc. As one example, a LIDAR system of the one or more sensors 201 generates sensor data (e.g., remote-detection sensor data) that includes the location (e.g., in three-dimensional space relative to the LIDAR system) of a number of points that correspond to objects that have reflected a ranging laser. For example, the LIDAR system can measure distances by measuring the Time of Flight (TOF) that it takes a short laser pulse to travel from the sensor to an object and back, calculating the distance from the known speed of light.

As another example, a RADAR system of the one or more sensors 201 generates sensor data (e.g., remote-detection sensor data) that includes the location (e.g., in three-dimensional space relative to the RADAR system) of a number of points that correspond to objects that have reflected ranging radio waves. For example, radio waves (e.g., pulsed or continuous) transmitted by the RADAR system can reflect off an object and return to a receiver of the RADAR system, giving information about the object's location and speed. Thus, a RADAR system can provide useful information about the speed of an object.

As yet another example, one or more cameras of the one or more sensors 201 may generate sensor data (e.g., remote-detection sensor data) including still or moving images. Various processing techniques (e.g., range imaging techniques such as, for example, structure from motion, structured light, stereo triangulation, and/or other techniques) can be performed to identify the location (e.g., in three-dimensional space relative to the one or more cameras) of a number of points that correspond to objects that are depicted in an image or images captured by the one or more cameras. Other sensor systems can identify the location of points that correspond to objects as well.

As another example, the one or more sensors 201 can include a positioning system. The positioning system can determine a current position of the vehicle 200. The positioning system can be any device or circuitry for analyzing the position of the vehicle 200. For example, the positioning system can determine a position by using one or more inertial sensors, by using a satellite positioning system such as the Global Positioning System (GPS), based on IP address, by using triangulation and/or proximity to network access points or other network components (e.g., cellular towers, Wi-Fi access points, etc.), and/or by other suitable techniques. The position of the vehicle 200 can be used by various systems of the vehicle autonomy system 202.

Thus, the one or more sensors 201 can be used to collect sensor data that includes information that describes the location (e.g., in three-dimensional space relative to the vehicle 20) of points that correspond to objects within the surrounding environment of the vehicle 200. In some implementations, the sensors 201 can be located at various different locations on the vehicle 200. As an example, in some implementations, one or more cameras and/or LIDAR sensors can be located in a pod or other structure that is mounted on a roof of the vehicle 200, while one or more RADAR sensors can be located in or behind the front and/or rear bumper(s) or body panel(s) of the vehicle 200. As another example, one or more cameras can be located at the front or rear bumper(s) of the vehicle 200 as well. Other locations can be used as well.

The pose system 230 receives some or all of the sensor data from the sensors 201 and generates vehicle poses for the vehicle 200. A vehicle pose describes the position and attitude of the vehicle 200. The position of the vehicle 200 is a point in three-dimensional space. In some examples, the position is described by values for a set of Cartesian coordinates, although any other suitable coordinate system may be used. The attitude of the vehicle 200 generally describes the way in which the vehicle 200 is oriented at its position. In some examples, attitude is described by a yaw about the vertical axis, a pitch about a first horizontal axis, and a roll about a second horizontal axis. In some examples, the pose system 230 generates vehicle poses periodically (e.g., every second, every half second, etc.). The pose system 230 appends time stamps to vehicle poses, where the time stamp for a pose indicates the point in time that is described by the pose. The pose system 230 generates vehicle poses by comparing sensor data (e.g., remote-sensor data) to map data 226 describing the surrounding environment of the vehicle 200.

In some examples, the pose system 230 comprises one or more localizers and a pose filter. Localizers generate pose estimates based on remote-sensor (e.g., LIDAR, RADAR) data. The pose filter generates vehicle poses, for example, based on pose estimates generated by one or more localizers and on motion sensor data, for example, from an inertial measurement unit (IMU), odometers, other encoders, etc. In some examples, the pose filter executes a Kalman filter or machine-learning algorithm to combine pose estimates from the one or more localizers with motion sensor data to generate vehicle poses. In some examples, localizers generate pose estimates at a frequency less than the frequency at which the pose system 230 generates vehicle poses. Accordingly, the pose filter generates some vehicle poses by extrapolating from a previous pose estimate utilizing motion sensor data.

The perception system 203 detects objects in the surrounding environment of the vehicle 200 based on sensor data, map data 226, and/or vehicle poses provided by the pose system 230. The map data 226, for example, may provide detailed information about the surrounding environment of the vehicle 200. The map data 226 can provide information regarding the identity and location of different roadways, segments of roadways, buildings, or other items or objects (e.g., lampposts, crosswalks, curbing, etc.); the location and direction of traffic lanes (e.g., the location and direction of a parking lane, a turning lane, a bicycle lane, or other lanes within a particular roadway); traffic control data (e.g., the location and instructions of signage, traffic lights, or other traffic control devices); and/or any other map data that provides information that assists the vehicle autonomy system 202 in comprehending and perceiving its surrounding environment and its relationship thereto. A roadway may be a place where the vehicle 200 can drive and may include, for example, a road, a street, a highway, a lane, a parking lot, a driveway, etc. The perception system 203 may utilize vehicle poses provided by the pose system 230 to place the vehicle 200 within the map data 226 and thereby predict which objects should be in the vehicle 200's surrounding environment.

In some examples, the perception system 203 determines state data for one or more of the objects in the surrounding environment of the vehicle 200. State data may describe a current state of an object (also referred to as features of the object). The state data for each object describes, for example, an estimate of the object's current location (also referred to as position); current speed (also referred to as velocity); acceleration; current heading; current orientation; size/shape/footprint (e.g., as represented by a bounding shape such as a bounding polygon or polyhedron); type/class (e.g., vehicle, pedestrian, bicycle, etc.); yaw rate; distance from the vehicle 200; minimum path to interaction with the vehicle 200; minimum time duration to interaction with the vehicle 200; and/or other state information.

In some implementations, the perception system 203 can determine state data for each object over a number of iterations. In particular, the perception system 203 can update the state data for each object at each iteration. Thus, the perception system 203 can detect and track objects, such as vehicles, that are proximate to the vehicle 200 over time.

The prediction system 204 is configured to predict one or more future positions for an object or objects in the environment surrounding the vehicle 200 (e.g., an object or objects detected by the perception system 203). The prediction system 204 can generate prediction data associated with one or more of the objects detected by the perception system 203. In some examples, the prediction system 204 generates prediction data describing each of the respective objects detected by the perception system 203.

Prediction data for an object can be indicative of one or more predicted future locations of the object. For example, the prediction system 204 may predict where the object will be located within the next 5 seconds, 20 seconds, 200 seconds, etc. Prediction data for an object may indicate a predicted trajectory (e.g., predicted path) for the object within the surrounding environment of the vehicle 200. For example, the predicted trajectory (e.g., path) can indicate a path along which the respective object is predicted to travel over time (and/or the speed at which the object is predicted to travel along the predicted path). The prediction system 204 generates prediction data for an object, for example, based on state data generated by the perception system 203. In some examples, the prediction system 204 also considers one or more vehicle poses generated by the pose system 230 and/or map data 226.

In some examples, the prediction system 204 uses state data indicative of an object type or classification to predict a trajectory for the object. As an example, the prediction system 204 can use state data provided by the perception system 203 to determine that a particular object (e.g., an object classified as a vehicle) approaching an intersection and maneuvering into a left-turn lane intends to turn left. In such a situation, the prediction system 204 can predict a trajectory (e.g., path) corresponding to a left turn for the vehicle such that the vehicle turns left at the intersection. Similarly, the prediction system 204 can determine predicted trajectories for other objects, such as bicycles, pedestrians, parked vehicles, etc. The prediction system 204 can provide the predicted trajectories associated with the object(s) to the motion planning system 205.

In some implementations, the prediction system 204 is a goal-oriented prediction system 204 that generates one or more potential goals, selects one or more of the most likely potential goals, and develops one or more trajectories by which the object can achieve the one or more selected goals. For example, the prediction system 204 can include a scenario generation system that generates and/or scores the one or more goals for an object and a scenario development system that determines the one or more trajectories by which the object can achieve the goals. In some implementations, the prediction system 204 can include a machine-learned goal-scoring model, a machine-learned trajectory development model, and/or other machine-learned models.

The motion planning system 205 determines a motion plan for the vehicle 200 based at least in part on the predicted trajectories associated with the objects within the surrounding environment of the vehicle 200, the state data for the objects provided by the perception system 203, vehicle poses provided by the pose system 230, and/or map data 226. Stated differently, given information about the current locations of objects and/or predicted trajectories of objects within the surrounding environment of the vehicle 200, the motion planning system 205 can determine a motion plan for the vehicle 200 that best navigates the vehicle 200 relative to the objects at such locations and their predicted trajectories on acceptable roadways.

In some implementations, the motion planning system 205 can evaluate one or more cost functions and/or one or more reward functions for each of one or more candidate motion plans for the vehicle 200. For example, the cost function(s) can describe a cost (e.g., over time) of adhering to a particular candidate motion plan, while the reward function(s) can describe a reward for adhering to the particular candidate motion plan. For example, the reward can be of opposite sign to the cost.

Thus, given information about the current locations and/or predicted future locations/trajectories of objects, the motion planning system 205 can determine a total cost (e.g., a sum of the cost(s) and/or reward(s) provided by the cost function(s) and/or reward function(s)) of adhering to a particular candidate pathway. The motion planning system 205 can select or determine a motion plan for the vehicle 200 based at least in part on the cost function(s) and the reward function(s). For example, the motion plan that minimizes the total cost can be selected or otherwise determined. The motion plan can be, for example, a path along which the vehicle 200 will travel in one or more forthcoming time periods. In some examples, the motion plan also includes a speed path and/or an acceleration path for the vehicle 200. In some implementations, the motion planning system 205 can be configured to iteratively update the motion plan for the vehicle 200 as new sensor data is obtained from the one or more sensors 201. For example, as new sensor data is obtained from the one or more sensors 201, the sensor data can be analyzed by the perception system 203, the prediction system 204, and the motion planning system 205 to determine the motion plan.

Each of the perception system 203, the prediction system 204, the motion planning system 205, and the pose system 230 can be included in or otherwise a part of the vehicle autonomy system 202 configured to determine a motion plan based at least in part on data obtained from the one or more sensors 201. For example, data obtained by the one or more sensors 201 can be analyzed by each of the perception system 203, the prediction system 204, and the motion planning system 205 in a consecutive fashion in order to develop the motion plan. While FIG. 2 depicts elements suitable for use in a vehicle autonomy system according to example aspects of the present disclosure, one of ordinary skill in the art will recognize that other vehicle autonomy systems can be configured to determine a motion plan for an autonomous vehicle based on sensor data.

The motion planning system 205 can provide the motion plan to the one or more vehicle controls 207 to execute the motion plan. For example, the one or more vehicle controls 207 can include throttle systems, brake systems, steering systems, and other control systems, each of which can include various vehicle controls (e.g., actuators or other devices that control gas flow, steering, braking, etc.) to control the motion of the vehicle 200. The various vehicle controls 207 can include one or more controllers, control devices, motors, and/or processors.

The vehicle controls 207 can include a brake control module 220. The brake control module 220 is configured to receive all or part of the motion plan and generate a braking command that applies (or does not apply) the vehicle brakes. In some examples, the brake control module 220 includes a primary system and a secondary system. The primary system may receive braking commands and, in response, brake the vehicle 200. The secondary system may be configured to determine a failure of the primary system and, if the primary system fails, brake the vehicle 200 in response to receiving the braking command.

A steering control system 232 is configured to receive all or part of the motion plan and generate a steering command. The steering command is provided to a steering system to provide a steering input to steer the vehicle 200. A lighting/auxiliary control module 236 may receive a lighting or auxiliary command. In response, the lighting/auxiliary control module 236 may control a lighting and/or auxiliary system of the vehicle 200. Controlling a lighting system may include, for example, turning on, turning off, or otherwise modulating headlights, parking lights, running lights, etc. Controlling an auxiliary system may include, for example, modulating windshield wipers, a defroster, etc.

A throttle control system 234 is configured to receive all or part of the motion plan and generate a throttle command. The throttle command is provided to an engine and/or engine controller, or other propulsion system component to control the engine or other propulsion system of the vehicle 200. The throttle correction system 240 operates in conjunction with the throttle control system 234 as described herein, to generate a biased throttle command.

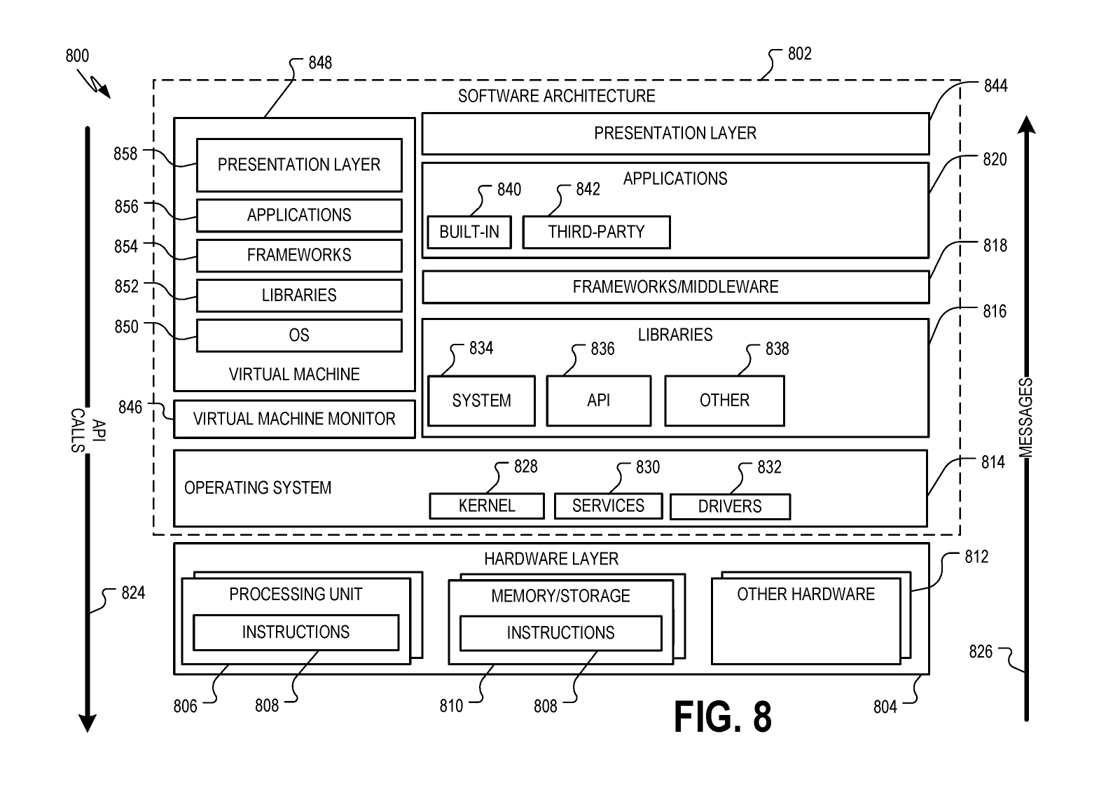

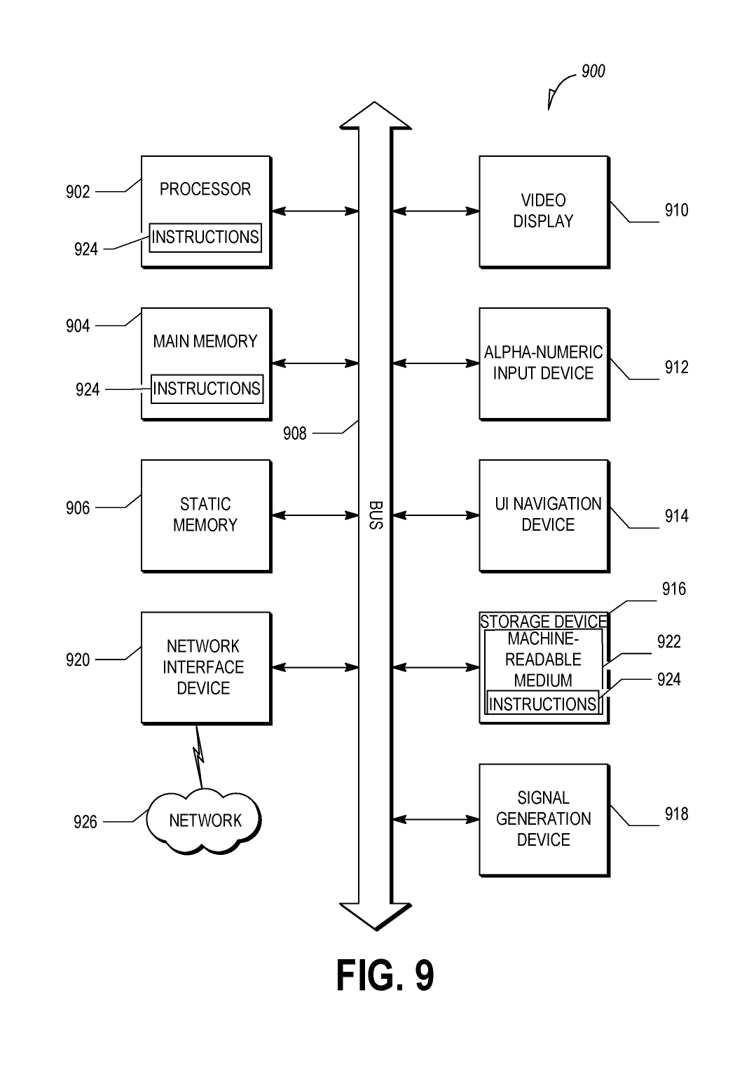

The vehicle autonomy system 202 includes one or more computing devices, such as a computing device 211, which may implement all or parts of the perception system 203, the prediction system 204, the motion planning system 205, and/or the pose system 230. The example computing device 211 can include one or more hardware processors 212 and one or more memory devices (collectively referred to as memory) 214. The one or more processors 212 can be any suitable processing device (e.g., a processor core, a microprocessor, an Application Specific Integrated Circuit (ASIC), a Field Programmable Gate Array (FPGA), a microcontroller, etc.) and can be one processor or a plurality of processors that are operatively connected. The memory 214 can include one or more non-transitory computer-readable storage mediums, such as Random Access Memory (RAM), Read Only Memory (ROM), Electrically Erasable Programmable Read Only Memory (EEPROM), Erasable Programmable Read Only Memory (EPROM), flash memory devices, magnetic disks, etc., and combinations thereof. The memory 214 can store data 216 and instructions 218 which can be executed by the processor 212 to cause the vehicle autonomy system 202 to perform operations. The example computing device 211 can also include a communication interface 219, which can allow the computing device 211 to communicate with other components of the vehicle 200 or external computing systems, such as via one or more wired or wireless networks. Additional descriptions of hardware and software configurations for computing devices, such as the computing device(s) 211, are provided herein at FIGS. 8 and 9.

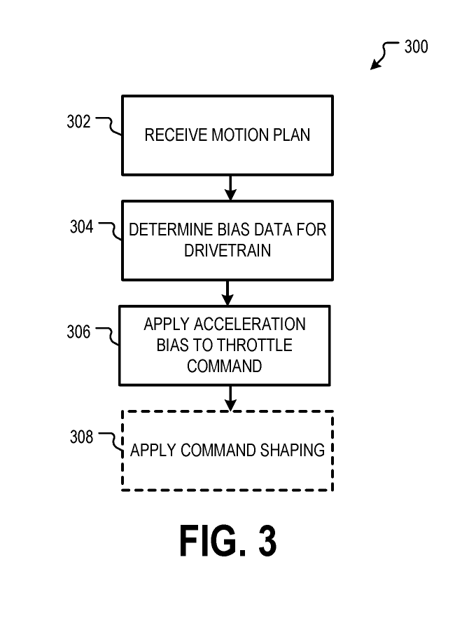

FIG. 3 is a flowchart showing one example of a process flow 300 that may be executed at an autonomous vehicle to apply drivetrain compensation to a throttle command. For example, the process flow 300 may be executed by a vehicle autonomy system, and/or a throttle control system and/or throttle correction system.

At operation 302, the vehicle autonomy system receives a motion plan. The motion plan includes a speed path and/or an acceleration path for the vehicle. For example, the motion plan may include an acceleration path that is to accelerate the vehicle from a first speed to a second speed that is greater than the first speed. In some examples, the vehicle autonomy system also includes a motion planning system that generates the motion plan.

At operation 304, the vehicle autonomy system determines drivetrain bias data for the vehicle. In some examples, this includes accessing drivetrain effect data describing drivetrain effects caused by the vehicle's drivetrain. For example, the drivetrain effect data may include data describing responses of the drivetrain to different throttle commands at different speeds. The drivetrain effect data may include, for example, predicted gear changes in the primary gearbox and/or in a range or splitter gear box. Drivetrain effect data, in some examples, may also reflect wheel spin or other drivetrain-specific effects that cause a difference between the called-for and actual acceleration. The drivetrain effect data may have been gathered by observing the vehicle or a vehicle having the same or a similar drivetrain. Also, in some examples, the drivetrain effect data is determined by considering known characteristics of the drivetrain such as, for example, shift points, etc. The vehicle autonomy system may determine the drivetrain bias, for example, by examining the drivetrain effect data to identify drivetrain effects at the current and/or future speed and acceleration of the vehicle. The drivetrain bias may represent an inverse of the drivetrain effects at the current and/or future speed and acceleration of the vehicle. For example, if drivetrain effects reduce the effective acceleration of the vehicle, the drivetrain bias may increase the called-for acceleration to compensate. At operation 306, the vehicle autonomy system applies the drivetrain bias to a throttle command to generate a biased throttle command. In various examples, this includes increasing the throttle called for by the throttle command to overcome drivetrain effects.

At optional operation 308, the vehicle autonomy system applies command shaping to the biased throttle command. Command shaping may be applied to smooth the biased throttle command. For example, applying command shaping may include applying a low-pass filter to a series of throttle commands to smooth abrupt changes to the amount of throttle applied. In some examples, applying command shaping may include applying a band-stop filter to a series of throttle commands to smooth throttle changes at a particular frequency and/or set of frequencies (e.g., harmonic frequencies of the tractor, trailer, or other subcomponents thereof, etc.).

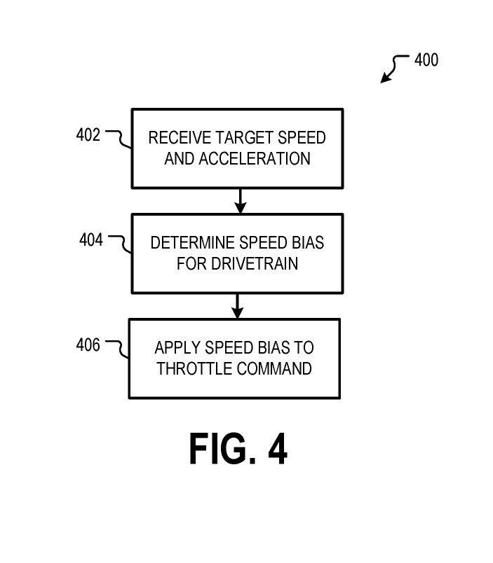

FIG. 4 is a flowchart showing one example of a process flow 400 that may be executed at an autonomous vehicle to generate a biased throttle command by applying a speed bias. For example, the process flow 400 may be executed by a vehicle autonomy system, and/or a throttle control system and/or throttle correction system.

At operation 402, the vehicle autonomy system receives and/or accesses target speed and target acceleration data. The target speed and target acceleration data, for example, are part of a motion plan generated by a motion planning system.

At operation 404, the vehicle autonomy system determines a speed bias for the drivetrain of the vehicle. The speed bias is a change to the target speed that is used to generate the throttle command. When drivetrain effects reduce the effective acceleration of the vehicle, the speed bias is positive.

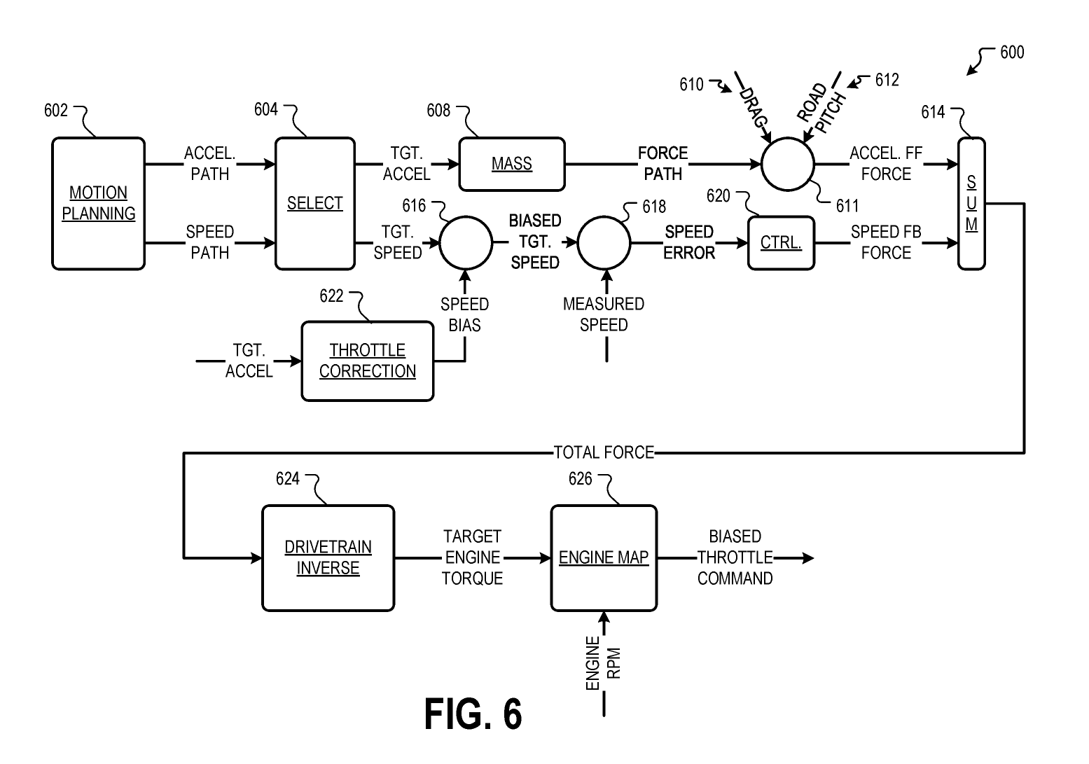

At operation 406, the vehicle autonomy system applies the speed bias to a throttle command to generate a biased throttle command. If the speed bias is positive, the vehicle autonomy system increases the throttle called for by the throttle command by an amount reflecting the speed bias. The speed bias may be all or part of drivetrain bias data that is used to generate the biased throttle command. An example workflow 600 for determining and applying a speed bias is described herein below with respect to FIG. 6.

In some examples, the speed bias is determined based on a target acceleration for the vehicle. Accordingly, the speed bias may be positive when the vehicle is accelerating and may be zero otherwise (e.g., when the target speed is reached). Consider an example in which a motion plan calls for a target speed of 60 miles per hour (MPH) and an acceleration of 2 MPH/s. In this example, drivetrain effects reduce the effective acceleration of the vehicle, for example, as described with reference to FIG. 1. To apply a speed bias, the vehicle autonomy system increases the called-for speed during the acceleration, bringing about a corresponding increase in the level of throttle called for by the throttle command. For example, the throttle command may be generated with a called-for speed higher than 60 MPH (e.g., 70 MPH, 75 MPH). This increases the throttle called for during acceleration. When the vehicle reaches the target speed, the vehicle autonomy system may cease to apply the speed bias.

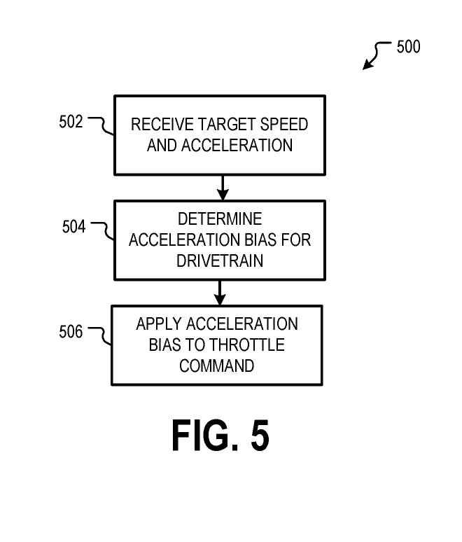

FIG. 5 is a flowchart showing one example of a process flow 500 that may be executed at an autonomous vehicle to generate a biased throttle command by applying an acceleration bias. For example, the process flow 500 may be executed by a vehicle autonomy system, and/or a throttle control system and/or throttle correction system.

At operation 502, the vehicle autonomy system receives and/or accesses target speed and target acceleration data. The target speed and target acceleration data, for example, are part of a motion plan generated by a motion planning system.

At operation 504, the vehicle autonomy system determines an acceleration bias for the drivetrain. The acceleration bias is a change to the target acceleration that is used to generate the throttle command. For example, if the target acceleration is 2 MPH/s and drivetrain effects bring about a reduction in the actual vehicle acceleration of 0.5 MPH/s over the desired acceleration range, then the acceleration bias may be 0.5 MPH/s.

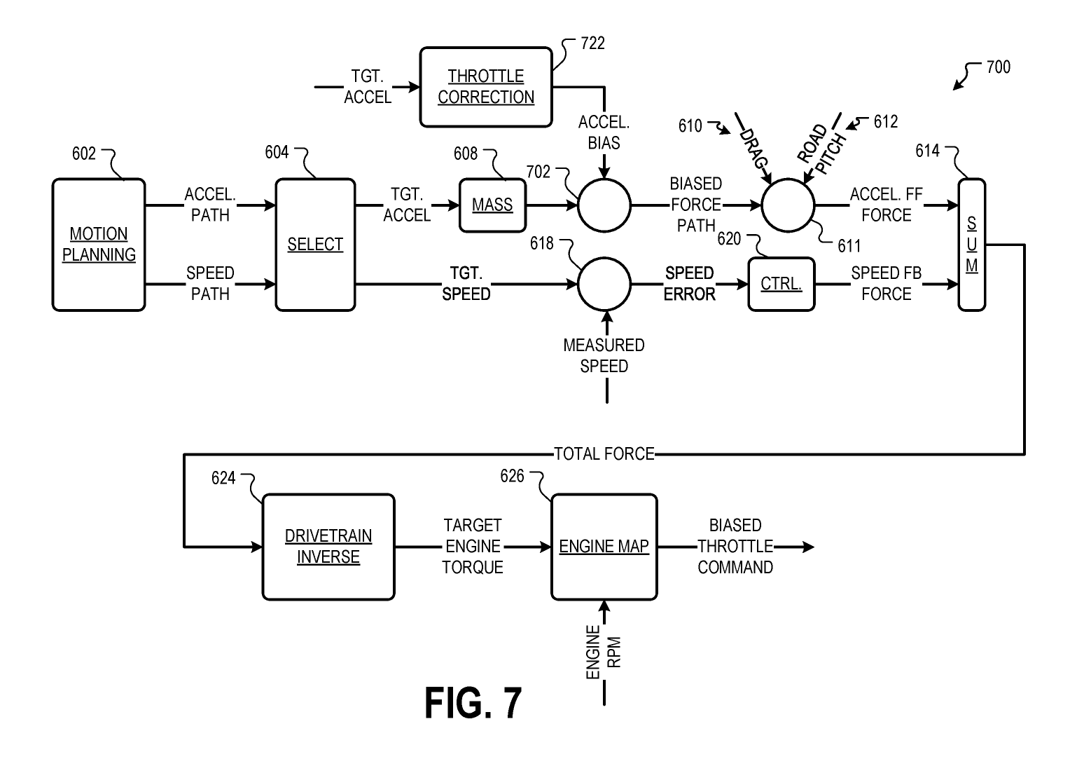

At operation 506, the vehicle autonomy system applies the acceleration bias to the throttle command to generate a biased throttle command. For example, if the acceleration bias is positive, the vehicle autonomy system increases the throttle command by an amount reflecting the acceleration bias. An example workflow 700 for determining and applying an acceleration bias is described herein below with respect to FIG. 7.

FIG. 6 is a chart showing one example workflow 600 that may be executed in an autonomous vehicle to generate a biased throttle command by applying a speed bias. The workflow 600 may be executed by various vehicle components as described herein.

A motion planning operation 602 generates a motion plan that includes an acceleration path and a speed path. The acceleration path describes a desired acceleration of the vehicle, and the speed path describes a desired speed of the vehicle. (A motion plan may also include other data, such as a direction path indicating a desired direction for the vehicle.) The acceleration and speed paths may be expressed over time. For example, the acceleration path may be or include a function expressing an acceleration of the vehicle as a function of time, as given by Equation [1] below:

accel_path(t) [1]

Similarly, the speed path may be or include a function expressing a speed of the vehicle as a function of time, as given by Equation [2] below:

speed_path(t) [2]

In Equations [1] and [2], t is time. The motion planning operation 602 may be performed by the vehicle autonomy system, such as, for example, by a motion planning system of the vehicle autonomy system.

A selection operation 604 generates a target speed and target acceleration for the vehicle. This may include evaluating the acceleration path and/or speed path for a value for the current time (e.g., the time at which the calculation is being performed). The selection operation 604 may be performed by the vehicle autonomy system, such as, for example, by a motion planning system and/or by a throttle control system.

An example target acceleration is given by Equation [3] below:

accel_path(now) [3]

Equation [3] is an evaluation of the acceleration path of Equation [1] for the time t=now, where now is the current time. Similarly, an example target speed is given by Equation [4] below:

speed_path(now) [4]

Equation [4] is an evaluation of the speed path of Equation [2] for the time t=now, again where now is the current time.

In some examples, the target acceleration is generated with a look-ahead time, as given by Equation [5] below:

accel_path(now+t_lookahead) [5]

Equation [5] is an evaluation of the acceleration path of Equation [1] for a time equal to the current time (now) plus a look-ahead time (t_lookahead). The look-ahead time may compensate for throttle lag or other delays between the time that a command is called for and when the result of the command is translated to the wheels of the vehicle. In some examples, a similar look-ahead time is used for generating the target speed, as given by Equation [6] below:

speed_path(now+t_lookahead) [6]

Equation [6] is an evaluation of the speed path of Equation [2] for a time equal to the current time (now) plus a look-ahead time (t_lookahead). The look-ahead time for the target speed may be the same as the look-ahead time for the target acceleration, or may be different. In some examples, a look-ahead time is used for the target acceleration but not for the target speed. Also, in some examples, a look-ahead time is used for the target speed but not for the target acceleration. Also, in some examples, the look-ahead time used for speed and the look-ahead time used for acceleration are not the same.

The target acceleration is provided to a mass operation 608. The mass operation 608 generates a force path representing the force to be applied to the vehicle to generate the target acceleration. The force path is provided to a correction operation 611. The correction operation 611 considers other forces that are encountered by the vehicle including, for example, a drag force 610 representing force applied to the vehicle due to drag. An example equation for finding aerodynamic drag is given by Equation [7] below:

force_drag=1/2 drag_area×speed² [7]

In some examples, the drag force 610 also considers drag generated by frictional forces on the vehicle.

The correction operation 611 may also consider a road pitch force 612. The road pitch force 612 includes a component of the force of gravity on the vehicle that acts parallel to the roadway, for example, if the roadway is not horizontal. An example equation for finding the road pitch force 612 is given by Equation [8] below:

force_road_pitch=m×g×sin(road_pitch) [8]

In Equation [8], m is the mass of the vehicle, g is the force of gravity, and road_pitch is an angle indicating how much the pitch of the roadway deviates from horizontal. The correction operation 611 generates an acceleration feedforward force indicating the force to be applied to the vehicle to generate the target acceleration. The operations 608 and 611 may be performed by the vehicle autonomy system such as, for example, by the motion planning system and/or throttle correction system. In some examples, all or part of the operations 608 and 611 are performed by a throttle control system.

The target acceleration is also provided to a throttle correction operation 622. The throttle correction operation 622 generates a speed bias. As described herein, the speed bias is to correct for drivetrain effects caused by the drivetrain of the vehicle. For example, generating the speed bias may include accessing drivetrain data describing the drivetrain of the vehicle. The target acceleration used at the throttle correction operation 622 may be a current target acceleration (Equation [3]) or may consider a look-ahead time (Equation [5]). The throttle correction operation 622 may be performed, for example, by the vehicle autonomy system such as, for example, by a throttle correction system and/or by a throttle control system.

The speed bias is added to the target speed at a correction operation 616. The result is a biased target speed. A measured speed of the vehicle is subtracted from the biased target speed at an error operation 618 to generate a speed error. The speed error is the difference between the biased target speed and the measured speed of the vehicle. The correction operation 616 and the error operation 618 may be performed by the vehicle autonomy system such as, for example, by a throttle correction system and/or by a throttle control system.

The speed error is provided to a control loop operation 620. The control loop operation 620 may implement any suitable type of controller for generating a speed feedback force to be applied to the vehicle to drive the speed error towards zero. In some examples, a proportional, integral, derivative (PID) controller is implemented. In some examples, in addition to or instead of generating a derivative of the speed error, the control loop operation 620 estimates the derivative of the speed error by finding a difference between the current acceleration (at t−now) and a look-ahead acceleration (at t−now+t_lookahead).

The acceleration feedforward force and speed feedback force are summed at a summing operation 614 to generate a total force to be applied to the vehicle. The summing operation 614 may be performed by the vehicle autonomy system such as, for example, by a throttle correction system and/or by a throttle control system.

The total force is provided to a drivetrain inverse operation 624 to generate a target engine torque. The target engine torque is the engine torque level that will generate the total force. The drivetrain inverse operation 624 may utilize an inverse model of the drivetrain that relates engine torque to force delivered to the vehicle. The target engine torque is provided to an engine map operation 626. The engine map operation 626 also receives a current engine speed, for example, in revolutions per minute (RPM), and generates the biased throttle command. The engine map operation 626 utilizes engine map data that relates the target engine torque and the current engine speed to a throttle command to bring about the target engine torque. The biased throttle command is provided, for example, to an engine controller of the vehicle to modulate the engine throttle. The operations 624 and 626 may be performed by the vehicle autonomy system such as, for example, by a throttle correction system and/or by a throttle control system.

In the example of FIG. 6, the speed feedback force is generated using a feedback arrangement. The speed feedback force is generated considering feedback in the form of the current speed of the vehicle. On the other hand, the acceleration feedforward force is determined using a feedforward arrangement. For example, the acceleration feedforward force is generated by estimating the drag force 610, road pitch force 612, and mass without receiving feedback. In this example, then, drivetrain correction data in the form of the speed bias is applied as part of a feedback system including the control loop operation 620.

FIG. 7 is a chart showing one example of a workflow 700 that may be executed by a throttle control system and/or throttle correction system to generate a biased throttle command by applying an acceleration bias. In the workflow 700, the target acceleration and target speed are generated by the motion planning operation 602 and selection operation 604 as described with respect to the workflow 600. In the workflow 700, the target speed is provided to the error operation 618 without applying the speed bias. Accordingly, in the workflow 700, the speed feedback force does not reflect drivetrain correction data.

In the workflow 700, the drivetrain correction data is applied on the acceleration side. A throttle correction operation 722 receives the target acceleration and generates an acceleration bias. The target acceleration may be a current target acceleration (at t=now) or a look-ahead acceleration (at t=now+t_lookahead). At operation 702, the acceleration bias is added to the force path generated by the mass operation 608 to generate a biased force path. The drag force 610 and road pitch force 612 are added to the biased force path to generate the total acceleration feedforward force, which is processed in conjunction with the speed feedback force as described herein to generate the biased throttle command.

In the example of FIG. 7, the speed feedback force is generated using a feedback arrangement, and the acceleration feedforward force is determined using a feedforward arrangement. The acceleration bias is applied as part of the feedforward arrangement.

In the examples of FIGS. 6 and 7, the biased throttle command is provided to an internal combustion engine, such as a diesel engine. In various examples, however, a biased throttle command can be generated for and applied to different types of propulsion systems, such as, for example, hybrid propulsion systems, electric propulsion systems, etc. For example, the inverse model of the drivetrain used at the drivetrain inverse operation 624 may relate to the type of propulsion system used. Also, for example, the engine map data used at the engine map operation 626 may relate to the type of propulsion system used. In some examples, the drivetrain inverse operation 624 and engine map operation 626 may be replaced by other operations or a single operation that translates the total force to a biased throttle command. For example, in a vehicle with an electric propulsion system, the total force may be related directly to a current or voltage level to be provided to the electric motor to bring about that force.

FIG. 8 is a block diagram 800 showing one example of a software architecture 802 for a computing device. The software architecture 802 may be used in conjunction with various hardware architectures, for example, as described herein. FIG. 8 is merely a non-limiting example of a software architecture 802, and many other architectures may be implemented to facilitate the functionality described herein. A representative hardware layer 804 is illustrated and can represent, for example, any of the above-referenced computing devices. In some examples, the hardware layer 804 may be implemented according to an architecture 900 of FIG. 9 and/or the architecture 802 of FIG. 8.

The representative hardware layer 804 comprises one or more processing units 806 having associated executable instructions 808. The executable instructions 808 represent the executable instructions of the software architecture 802, including implementation of the methods, modules, components, and so forth of FIGS. 1-7. The hardware layer 804 also includes memory and/or storage modules 810, which also have the executable instructions 808. The hardware layer 804 may also comprise other hardware 812, which represents any other hardware of the hardware layer 804, such as the other hardware illustrated as part of the architecture 900.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and a presentation layer 844. Operationally, the applications 820 and/or other components within the layers may invoke application programming interface (API) calls 824 through the software stack and receive a response, returned values, and so forth illustrated as messages 826 in response to the API calls 824. The layers illustrated are representative in nature, and not all software architectures have all layers. For example, some mobile or special-purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of a hardware or software interrupt and, in response, cause the software architecture 802 to pause its current processing and execute an Interrupt Service Routine (ISR) when an interrupt is received. The ISR may generate an alert.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), WiFi® drivers, near-field communication (NFC) drivers, audio drivers, power management drivers, and so forth depending on the hardware configuration.

The libraries 816 may provide a common infrastructure that may be used by the applications 820 and/or other components and/or layers. The libraries 816 typically provide functionality that allows other software modules to perform tasks in an easier fashion than by interfacing directly with the underlying operating system 814 functionality (e.g., kernel 828, services 830, and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be used by the applications 820 and/or other software components/modules. For example, the frameworks 818 may provide various graphical user interface (GUI) functions, high-level resource management, high-level location services, and so forth. The frameworks 818 may provide a broad spectrum of other APIs that may be used by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. The third-party applications 842 may include any of the built-in applications 840 as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 842 may invoke the API calls 824 provided by the mobile operating system such as the operating system 814 to facilitate functionality described herein.

The applications 820 may use built-in operating system functions (e.g., kernel 828, services 830, and/or drivers 832), libraries (e.g., system libraries 834, API libraries 836, and other libraries 838), or frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with a user.

Some software architectures use virtual machines. For example, systems described herein may be executed using one or more virtual machines executed at one or more server computing machines. In the example of FIG. 8, this is illustrated by a virtual machine 848. A virtual machine creates a software environment where applications/modules can execute as if they were executing on a hardware computing device. The virtual machine 848 is hosted by a host operating system (e.g., the operating system 814) and typically, although not always, has a virtual machine monitor 846, which manages the operation of the virtual machine 848 as well as the interface with the host operating system (e.g., the operating system 814). A software architecture executes within the virtual machine 848, such as an operating system 850, libraries 852, frameworks/middleware 854, applications 856, and/or a presentation layer 858. These layers of software architecture executing within the virtual machine 848 can be the same as corresponding layers previously described or may be different.

FIG. 9 is a block diagram illustrating a computing device hardware architecture 900, within which a set or sequence of instructions can be executed to cause a machine to perform examples of any one of the methodologies discussed herein. The architecture 900 may describe a computing device for executing the vehicle autonomy system, throttle correction system, etc. described herein. The architecture 900 may operate as a standalone device or may be connected (e.g., networked) to other machines. In a networked deployment, the architecture 900 may operate in the capacity of either a server or a client machine in server-client network environments, or it may act as a peer machine in peer-to-peer (or distributed) network environments. The architecture 900 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 900 includes a hardware processor unit 902 comprising at least one processor (e.g., a central processing unit (CPU), a graphics processing unit (GPU), or both, processor cores, compute nodes, etc.). The architecture 900 may further comprise a main memory 904 and a static memory 906, which communicate with each other via a link 908 (e.g., a bus). The architecture 900 can further include a video display unit 910, an input device 912 (e.g., a keyboard), and a UI navigation device 914 (e.g., a mouse). In some examples, the video display unit 910, input device 912, and UI navigation device 914 are incorporated into a touchscreen display. The architecture 900 may additionally include a storage device 916 (e.g., a drive unit), a signal generation device 918 (e.g., a speaker), a network interface device 920, and one or more sensors (not shown), such as a Global Positioning System (GPS) sensor, compass, accelerometer, or other sensor.

In some examples, the processor unit 902 or another suitable hardware component may support a hardware interrupt. In response to a hardware interrupt, the processor unit 902 may pause its processing and execute an ISR, for example, as described herein.

The storage device 916 includes a machine-readable medium 922 on which is stored one or more sets of data structures and instructions 924 (e.g., software) embodying or used by any one or more of the methodologies or functions described herein. The instructions 924 can also reside, completely or at least partially, within the main memory 904, within the static memory 906, and/or within the processor unit 902 during execution thereof by the architecture 900, with the main memory 904, the static memory 906, and the processor unit 902 also constituting machine-readable media.

### Executable Instructions and Machine-Storage Medium

The various memories (i.e., 904, 906, and/or memory of the processor unit(s) 902) and/or the storage device 916 may store one or more sets of instructions and data structures (e.g., instructions) 924 embodying or used by any one or more of the methodologies or functions described herein. These instructions, when executed by the processor unit(s) 902, cause various operations to implement the disclosed examples.

As used herein, the terms “machine-storage medium,” “device-storage medium,” and “computer-storage medium” (referred to collectively as “machine-storage medium”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 924 can further be transmitted or received over a communications network 926 using a transmission medium via the network interface device 920 using any one of a number of well-known transfer protocols (e.g., HTTP). Examples of communication networks include a local area network (LAN), a wide area network (WAN), the Internet, mobile telephone networks, plain old telephone service (POTS) networks, and wireless data networks (e.g., Wi-Fi, 3G, 4G LTE/LTE-A, 5G, or WiMAX networks). The term “transmission medium” shall be taken to include any intangible medium that is capable of storing, encoding, or carrying instructions for execution by the machine, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other examples can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Description, various features can be grouped together to streamline the disclosure. However, the claims cannot set forth every feature disclosed herein, as examples can feature a subset of said features. Further, examples can include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

1. A vehicle system for at least partially controlling a vehicle, comprising:
at least one hardware processor unit programmed to perform operations comprising:
accessing motion plan data for the vehicle;
generating drivetrain bias data representative of drivetrain effects of the vehicle;
generating a biased throttle command using the motion plan data and the drivetrain bias data; and
applying the biased throttle command to a propulsion system of the vehicle.

2. The vehicle system of claim 1, wherein the generating of the drivetrain bias data also uses a predicted gear change of a transmission of a drivetrain of the vehicle.

3. The vehicle system of claim 1, wherein the motion plan data comprises a target speed and a target acceleration, wherein the drivetrain bias data comprises a speed bias, and wherein the at least one hardware processor unit is further programmed to perform operations comprising determining the speed bias based at least in part on the target acceleration.

4. The vehicle system of claim 3, wherein the at least one hardware processor unit is further programmed to perform operations comprising:
determining a speed error based at least in part on the target speed, the speed bias, and a measured speed of the vehicle; and
executing a control loop based at least in part on the speed error to generate a speed feedback force.

5. The vehicle system of claim 3, wherein the at least one hardware processor unit is further programmed to perform operations comprising determining an acceleration bias using the target acceleration, wherein the generating of the biased throttle command uses a speed feedback force and the acceleration bias.

6. The vehicle system of claim 5, wherein the at least one hardware processor unit is further programmed to perform operations comprising:
applying an inverse drivetrain model to generate a target engine torque using the speed feedback force and the acceleration bias; and
applying engine map data to generate the biased throttle command using the target engine torque.

7. The vehicle system of claim 3, wherein the target acceleration describes a current time plus a look-ahead time.

8. The vehicle system of claim 1, wherein the motion plan data comprises a target speed and a target acceleration, wherein the drivetrain bias data comprises an acceleration bias, wherein the at least one hardware processor unit is further programmed to perform operations comprising generating the acceleration bias using the target acceleration, and wherein the generating of the biased throttle command uses the acceleration bias.

9. The vehicle system of claim 1, wherein the drivetrain bias data comprises an acceleration bias and wherein generating the biased throttle command comprises determining an acceleration feedforward force using the acceleration bias.

10. The vehicle system of claim 1, wherein the drivetrain bias data comprises a speed bias and wherein generating the biased throttle command comprises determining a speed feedback force using the speed bias.

11. A method for at least partially controlling a vehicle, comprising:
accessing motion plan data for the vehicle;
generating drivetrain bias data representative of drivetrain effects of the vehicle;
generating a biased throttle command using the motion plan data and the drivetrain bias data; and
applying the biased throttle command to a propulsion system of the vehicle.

12. The method of claim 11, wherein the motion plan data comprises a target speed and a target acceleration, wherein the drivetrain bias data comprises a speed bias, and further comprising determining the speed bias based at least in part on the target acceleration.

13. The method of claim 12, further comprising:
determining a speed error based at least in part on the target speed, the speed bias, and a measured speed of the vehicle; and
executing a control loop based at least in part on the speed error to generate a speed feedback force.

14. The method of claim 12, further comprising determining an acceleration bias using the target acceleration, wherein the generating of the biased throttle command uses a speed feedback force and the acceleration bias.

15. The method of claim 14, further comprising:
applying an inverse drivetrain model to generate a target engine torque using the speed feedback force and the acceleration bias; and
applying engine map data to generate the biased throttle command using the target engine torque.

16. The method of claim 12, wherein the target acceleration describes a current time plus a look-ahead time.

17. The method of claim 11, wherein the motion plan data comprises a target speed and a target acceleration, wherein the drivetrain bias data comprises an acceleration bias, further comprising generating the acceleration bias using the target acceleration, and wherein the generating of the biased throttle command uses the acceleration bias.

18. The method of claim 11, wherein the drivetrain bias data comprises an acceleration bias and wherein generating the biased throttle command comprises determining an acceleration feedforward force using the acceleration bias.

19. The method of claim 11, wherein the drivetrain bias data comprises a speed bias and wherein generating the biased throttle command comprises determining a speed feedback force using the speed bias.

20. A machine-readable medium comprising instructions thereon that, when executed by at least one hardware processor, cause the at least one hardware processor to perform operations comprising:
accessing motion plan data for a vehicle;
generating drivetrain bias data representative of drivetrain effects of the vehicle;
generating a biased throttle command using the motion plan data and the drivetrain bias data; and
applying the biased throttle command to a propulsion system of the vehicle.
